(19) United States
(12) Patent Application Publication
(10) Pub. No.: US 2007/0054034 A1
(43) Pub. Date: Mar. 8, 2007

(54) Method for fabricating dielectric layers of a plasma display panel

(76) Inventor: Ching-Hsiung Lu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,325

(22) Filed: Sep. 7, 2005

(51) Int. Cl. B05D 5/12

(52) U.S. Cl. 427/64; 427/68

(57) ABSTRACT

A method of fabricating dielectric layers of a plasma display panel is disclosed. First, a substrate is provided, in which the surface of the substrate further comprises a plurality of parallel electrodes. Next, a first dielectric layer is formed over the surface of the substrate to cover the electrodes and a first firing process is performed on the first dielectric layer by utilizing a first temperature. Next, a second dielectric layer is formed over the surface of the first dielectric layer and a second firing process is performed on the second dielectric layer by utilizing a second temperature, in which the second temperature is higher than the first temperature.

### BACKGROUND OF THE INVENTION

1. Field of the Invention

The invention relates to a method of fabricating dielectric layers of a plasma display panel, and more particularly, to a method of first utilizing a low temperature and then utilizing a higher temperature for fabricating dielectric layers of a plasma display panel.

2. Description of the Prior Art

Plasma display panels (PDPs) are flat displays utilizing gases to generate electricity for illumination. The characteristics of plasma display panels include light weight, thinness, large scale expandability, and wide angle of vision. In general, the illumination of plasma display panels is caused by illuminating the ultraviolet lights produced by plasmas onto fluorescent bodies, such that lights can be visible from the fluorescent bodies eventually.

Please refer to FIG. 1. FIG. 1 is a perspective diagrams showing a plasma display panel 10 according to the prior art. As shown in FIG. 1, the plasma display panel 10, which can be driven by interflow of electricity, includes a housing (not shown), a back plate 12, and a front plate 14 disposed in parallel above the back plate 12. A plurality of electrode pairs 16 is disposed in parallel over the lower surface of the front plate 14, in which each of the electrodes includes a common electrode 17, a scan electrode 18, a dielectric layer 20 disposed over the lower surface of the front plate 14 and covering the electrode pairs 16, and a passivation layer 22 composed of magnesium oxide (MgO) formed over the lower surface of the dielectric layer 20 for protecting dielectric layer 20 from deterioration caused by plasma splashing. Additionally, a plurality of data electrodes 24 is disposed in parallel over the upper surface of the back plate 12, a dielectric layer 26 is disposed above the upper surface of the back plate 12 and covering the data electrodes 24, a plurality of ribs 28 disposed above the dielectric layer 26, and three different colors of phosphor including blue, red, an green of 30B, 30R, 30G are disposed between the ribs 28. Moreover, ionized gases (not shown) are inserted between each two adjacent ribs and the top of the ribs 28 is fixed over the lower surface of the passivation layer 22 to prevent the plasma on two sides of the ribs 28 from interacting with each other.

The common electrode 17 and the scan electrode 18 both include a sustain electrode 32 and a bus electrode 34. The sustain electrode 32 is a transparent electrode having greater width, in which the electrode is typically composed of indium tin oxide (ITO) to initiate and sustain electricity. The bus electrode 34 on the other hand, is a thinner and non-transparent metal electrode, in which the electrode is usually composed chromium-copper-chromium or silver. Additionally, the bus electrode 34 is disposed in parallel over the surface of the sustain electrode 32 to support the sustain electrode 32 for generating electricity and reducing the electrical resistance of the common electrode 17 and scan electrode 18. Moreover, a plurality of blue display cells 36B, red display cells 36R, and green display cells 36G is formed at the meeting point of the data electrode 24 (also serving as a metal electrode) and electrode pairs 16 to generate blue, red, and green lights, in which the display cells are divided by the ribs 28 individually. Preferably, the primary function of the dielectric layers 20 and 26 is to provide the required capacitance, place constraints on the electrical current for preventing short circuits and at the same time, accumulate electrical potentials.

By utilizing the conventional method of fabricating the dielectric layers 20 and 26, processes including dielectric layer printing, drying, and firing are required to be performed two times or more, in which the dielectric layer from each process can be composed of same or different materials. For instance, if the dielectric layers are composed of same material for every fabrication process, the firing temperature utilized for each process will be the same. Consequently, problems such as yellowing phenomenon and electrical migration caused by the reaction between the dielectric layers and the metal electrodes will result after continuous high temperature firing and increase the amount of gas bubbles generated within the dielectric layers, degrade the quality of the display panel, increase energy consumption and decrease the life expectancy of the equipment. Alternatively, if the dielectric layers are composed of different materials for each different fabrication process, a higher temperature is first utilized to fire the dielectric layers, and a lower temperature is utilized afterwards to fire the dielectric layers. By utilizing this method, numerous types of materials are needed, thereby increasing the complexity of management of the materials and the total cost of the fabrication processes.

### SUMMARY OF THE INVENTION

It is therefore an objective of the present invention to provide a method for fabricating the dielectric layers of a plasma display panel for solving the above-mentioned problems.

According to the present invention, a method of fabricating dielectric layers of a plasma display panel includes: providing a substrate, in which the surface of the substrate further comprises a plurality of parallel electrodes; forming a first dielectric layer over the surface of the substrate for covering the electrodes; performing a first firing process on the first dielectric layer by utilizing a first temperature; forming a second dielectric layer over the surface of the first dielectric layer; and performing a second firing process on the second dielectric layer by utilizing a second temperature, in which the second temperature is higher than the first temperature.

By first utilizing a lower firing temperature and then a higher firing temperature to form the dielectric layers of a plasma display panel, the method of fabricating dielectric layers of a plasma display panel according to the present invention is able to reduce problems such as yellowing phenomenon and electrical migrations, and to improve the durability of the dielectric layer as a result of gas bubbles, to decrease power consumption, and to increase the life expectancy of the equipment. Moreover, the present invention is also suitable for dielectric layers only composed of a single material, thereby simplifying the management of materials and fabrication processes and reducing the overall fabrication cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram showing a plasma display panel according to the prior art.

FIG. 2 and FIG. 3 are perspective diagrams showing the method of fabricating dielectric layers of a plasma display panel according to the preferred embodiment of the present invention.

FIG. 4 is a perspective diagram showing the relationship between the firing temperature and time of the dielectric layer according to the present invention.

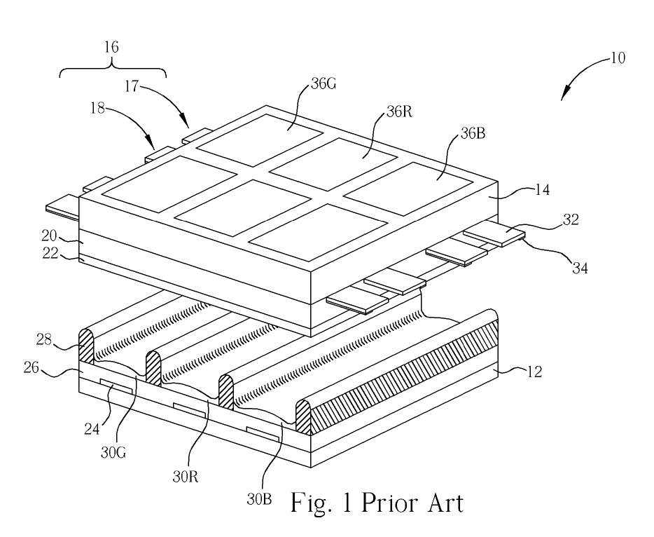

### DETAILED DESCRIPTION

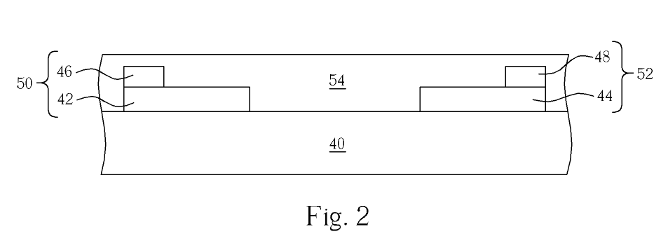

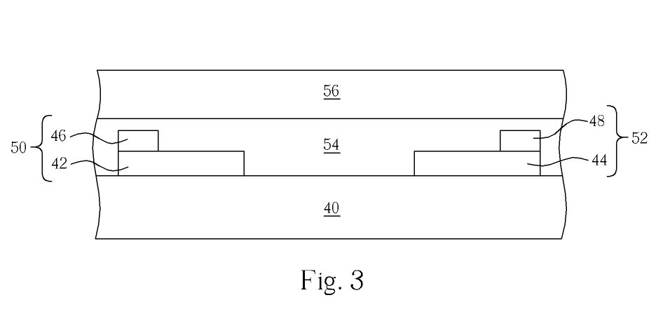

Please refer to FIG. 2 and FIG. 3. FIG. 2 and FIG. 3 are perspective diagrams showing the method of fabricating dielectric layers of a plasma display panel according to the preferred embodiment of the present invention. As shown in FIG. 2, a substrate 40 is provided, in which the substrate 40 is a front plate or back plate of a plasma display panel. According to the preferred embodiment of the present invention, the substrate 40 is the front plate of a plasma display panel, in which the substrate 40 is composed of transparent materials such as glass or quartz. Additionally, a plurality of first transparent electrodes 42 and second transparent electrodes 44 are disposed in parallel over the surface of the substrate 40, in which the first transparent electrodes 42 and second transparent electrodes 44 are composed of transparent materials such as indium tin oxide (ITO) or indium zinc oxide (IZO) to serve as a plurality of sustain electrodes for initiating and sustaining electric power. Next, a plurality of first metal electrodes 46 and second metal electrodes 48 are formed over the surface of the first transparent electrodes 42 and second transparent electrodes 44, in which the first metal electrodes 46 and second metal electrodes 48 are composed of chromium-copper-chromium or silver. Preferably, the first metal electrodes 46 and second metal electrodes 48 are utilized as a plurality of bus electrodes and form a common electrode 50 and a scan electrode 52 with the corresponding sustaining electrodes, such that the metal electrodes are utilized to support the first transparent electrodes 42 and second transparent electrodes 44 for generating electricity and lower the electrical resistance of common electrodes 50 and scan electrodes 52.

Next, a printing process and a drying process or a taping process are performed to form a first dielectric layer 54 over the surface of the substrate 40 and cover the common electrode 50 and the scan electrode 52. Next, a first firing process is performed on the first dielectric layer, in which a first firing temperature is utilized to fire the first dielectric layer 54. According to the preferred embodiment of the present invention, the first firing process is performed by setting the first firing temperature at approximately 550° C. for firing the first dielectric layer 54 for ten minutes.

Next, a printing process and a drying process or a taping process are performed to form a second dielectric layer 56 over the surface of the first dielectric layer 54, as shown in FIG. 3. Next, a second firing process is performed on the second dielectric layer 56 according to the material property (i.e. softening temperature) of the second dielectric layer 56, such that a second firing temperature is utilized for performing the second firing process. According to the preferred embodiment of the present invention, the second firing process is performed on the second dielectric layer 56 by utilizing the second firing temperature of 570° C. for ten minutes.

Peferably, the first dielectric layer 54 and the second dielectric layer 56 can be composed of same transparent dielectric materials or different transparent dielectric material with similar softening temperature. Next, the second firing temperature is set roughly between 570° C. to 600° C. according to the property (i.e. softening temperature) of the transparent dielectric material and the first firing temperature is then set by reducing the second firing temperature by 5° C. to 50° C. According to the preferred embodiment of the present invention, the first firing temperature is obtained by decreasing the second firing temperature by 20° C. Consequently, the present invention is able to prevent the dielectric layers from reacting with the metal electrodes due to the continuous high temperature firing process, thereby avoiding yellowing phenomenon and electrical migrations, and also to prevent the degradation of the dielectric layer from gas bubbles generated within the dielectric layer, thereby improving the quality of the display panel. Despite the fact that there are only two firing processes introduced, the present invention is applicable to other fabrication processes containing more than two firing processes.

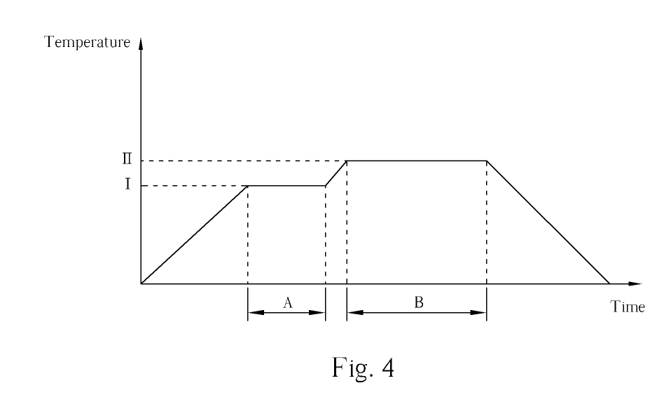

Please refer to FIG. 4. FIG. 4 is a perspective diagram showing the relationship between the firing temperature and time of the dielectric layer according to the present invention. As shown in FIG. 4, a firing equipment (not shown) is first heated to obtain a first firing temperature 1, such as 550° C. and a first firing process is performed on the first dielectric layer 54 within a first temperature sustaining area A. Next, the temperature of the firing equipment is increased from the first firing temperature I to a second firing temperature 11, such as 570° C., and a second firing process is performed on the second dielectric layer 56 within a second temperature sustaining area B. Since a lower temperature treatment is utilized before a higher temperature, the present invention is able to effectively increase the quality of the firing process, decrease the consumption of energy, and increase the life expectancy of the equipment.

In contrast to the conventional technique, the method of fabricating dielectric layers of a plasma display panel according to the present invention first utilizes a lower firing temperature and then a higher firing temperature to form the dielectric layers of a plasma display panel, thereby reducing problems such as yellowing phenomenon and electrical migrations, improving the durability of the dielectric layer as a result of gas bubbles, reducing power consumption, and increasing the life expectancy of the equipment. Moreover, the present invention is also suitable for dielectric layers only composed of single material, thereby simplifying the management of materials and fabrication processes and reducing the overall fabrication cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of fabricating dielectric layers of a plasma display panel comprising:
providing a substrate, wherein the surface of the substrate further comprises a plurality of parallel electrodes;
forming a first dielectric layer over the surface of the substrate for covering the electrodes;
performing a first firing process on the first dielectric layer by utilizing a first temperature;
forming a second dielectric layer over the surface of the first dielectric layer; and
performing a second firing process on the second dielectric layer by utilizing a second temperature, wherein the second temperature is higher than the first temperature.

2. The method of claim 1, wherein the first dielectric layer and the second dielectric layer are comprised of same materials.

3. The method of claim 1, wherein the first dielectric layer and the second dielectric layer are formed on the substrate separately by utilizing a printing process.

4. The method of claim 3, wherein the method further comprises a drying process after the printing process.

5. The method of claim 1, wherein the first dielectric layer and the second dielectric layer are formed on the substrate separately by utilizing a taping process.

6. The method of claim 1, wherein the substrate is comprised of glass.

7. The method of claim 1, wherein the substrate is the front plate of a plasma display panel.

8. The method of claim 7, wherein each of the electrodes comprises a transparent electrode disposed over the surface of the front plate and a metal electrode disposed over the surface of the transparent electrode.

9. The method of claim 1, wherein the substrate is the back plate of a plasma display panel.

10. The method of claim 1, wherein the first temperature is the temperature of a first temperature sustaining area and the second temperature is the temperature of a second temperature sustaining area.

11. The method of claim 1, wherein the range of the second temperature is between 570° C. and 600° C. and the range difference between the first temperature and the second temperature is 5° C. to 50° C.
